(19) United States
(12) Patent Application Publication
(10) Pub. No.: US 2014/0370480 A1
(43) Pub. Date: Dec. 18, 2014

(54) STORAGE MEDIUM, APPARATUS, AND METHOD FOR INFORMATION PROCESSING

(71) Applicant: FUJI XEROX CO., LTD., Tokyo (JP)

(72) Inventors: Hiroki SUGIBUCHI, Kanagawa (JP); Hiroshi UMEMOTO, Kanagawa (JP); Motoyuki TAKAAI, Kanagawa (JP)

(73) Assignee: FUJI XEROX CO., LTD., Tokyo (JP)

(21) Appl. No.: 14/056,314

(22) Filed: Oct. 17, 2013

(30) Foreign Application Priority Data
Jun. 17, 2013 (JP) 2013-126828

(51) Int. Cl. G09B 5/02

(52) U.S. Cl. CPC G09B 5/02
USPC 434/322

(57) ABSTRACT

A non-transitory computer readable medium storing a program causing a computer to execute a process for information processing includes evaluating plural learning models; displaying an evaluation result of the evaluation; selecting a first learning model from the displayed plural learning models; estimating attribute information to be applied to document information, in accordance with the first learning model; and executing learning by using at least one of the plural learning models while the document information with the estimated attribute information applied serves as an input.

### CROSS-REFERENCE TO RELATED APPLICATIONS

This application is based on and claims priority under 35 USC 119 from Japanese Patent Application No. 2013-126828 filed Jun. 17, 2013.

### BACKGROUND

The present invention relates to a storage medium storing an information processing program, an information processing apparatus, and an information processing method.

### SUMMARY

According to a first aspect of the invention, a non-transitory computer readable medium storing a program causing a computer to execute a process for information processing includes evaluating plural learning models; displaying an evaluation result of the evaluation; selecting a first learning model from the displayed plural learning models; estimating attribute information to be applied to document information, in accordance with the first learning model; and executing learning by using at least one of the plural learning models while the document information with the estimated attribute information applied serves as an input.

### BRIEF DESCRIPTION OF THE DRAWINGS

Exemplary embodiments of the present invention will be described in detail based on the following figures, wherein:

FIG. 1 is a schematic view for illustrating an example configuration of an information processing system according to an exemplary embodiment of the invention.

FIG. 2 is a block diagram showing an example configuration of the information processing apparatus according to the exemplary embodiment.

FIG. 3 is a schematic view for illustrating an example of a learning model generating operation.

FIG. 4 is a schematic view for illustrating an example configuration of an attribute information input screen that receives an input of an attribute name.

FIG. 5 is a schematic view for illustrating an example configuration of a classification screen that receives start of learning.

FIG. 6 is a schematic view for illustrating an example configuration of a learn result display screen indicative of a content of evaluation information of a learn result.

FIG. 7 is a schematic view for illustrating an example of a re-learning operation.

FIG. 8 is a schematic view for illustrating an example configuration of a learning model selection screen.

FIG. 9 is a schematic view for illustrating an example configuration of an attribute information estimation screen.

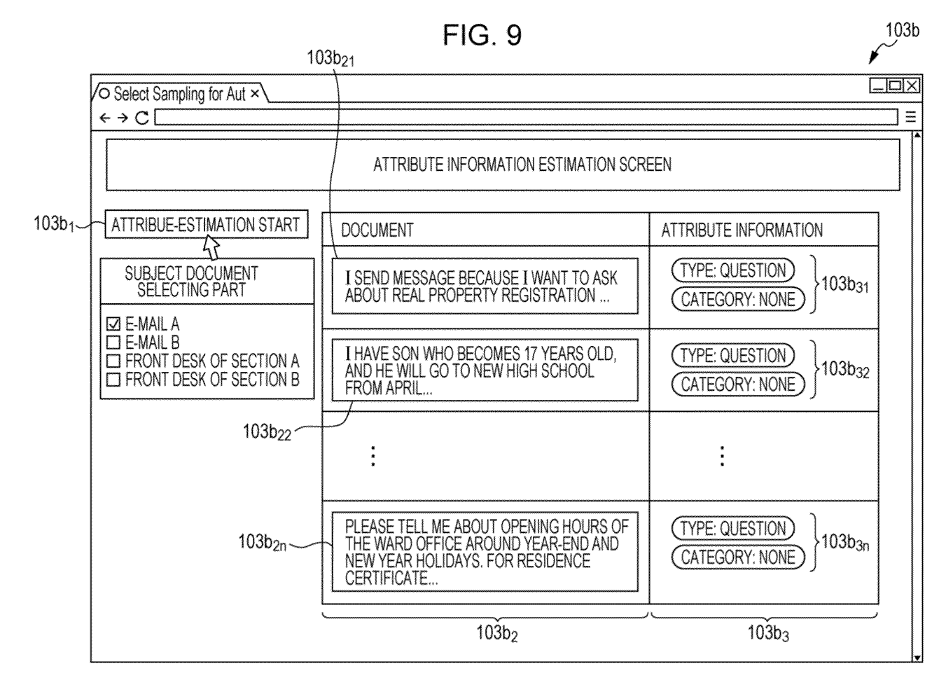

FIG. 10 is a schematic view for illustrating an example configuration of a Learning model selection screen.

FIG. 11 is a schematic view for illustrating an example configuration of a learning model analysis screen before re-learning.

FIG. 12 is a schematic view for illustrating an example configuration of a learning model analysis screen after re-learning.

FIG. 13 is a schematic view for illustrating an example of an answering operation.

FIG. 14 is a schematic view for illustrating an example configuration of a question input screen.

FIG. 15 is a schematic view for illustrating an example configuration of an answer display screen.

### DETAILED DESCRIPTION

### Exemplary Embodiment

### Configuration of Information Processing System

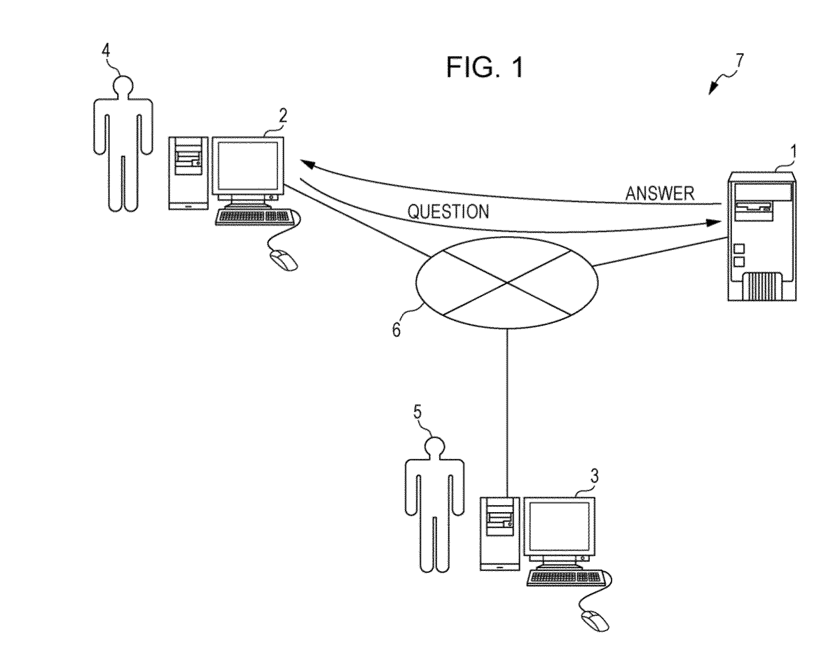

FIG. 1 is a schematic view for illustrating an example configuration of an information processing system according to an exemplary embodiment of the invention.

The information processing system 7 includes an information processing apparatus 1, a terminal 2, and a terminal 3 which are connected to make communication through a network 6. The terminals 2 and 3 each are illustrated as a single device; however, may be plural connected devices.

The information processing apparatus 1 includes electronic components, such as a central processing unit (CPU) having a function for processing information, and a hard disk drive (HDD) or a flash memory having a function for storing information.

When the information processing apparatus 1 receives document information as a question from the terminal 2, the information processing apparatus 1 classifies the document information into one of plural attributes, selects answer information as an answer to the question in accordance with the attribute applied as the classification result, and transmits the answer information to the terminal 2. The information processing apparatus 1 is administered by the terminal 3. The document information may use, for example, text information transmitted through information communication, such as an e-mail or chat, information in which speech information is converted into text, and information obtained through optical scanning on a paper document etc.

Alternatively, the information processing apparatus 1 may transmit an answer to a question to the terminal 3, which is administered by an administrator 5, without transmitting the answer to the terminal 2. Still alternatively, the information processing apparatus 1 may transmit answer information, which is selected by the administrator 5 from plural pieces of answer information displayed on the terminal 3, to the terminal 2.

Further alternatively, a question may be transmitted from the terminal 2 not to the information processing apparatus 1 but to the terminal 3, the administrator 5 may transmit the question to the information processing apparatus 1 by using the terminal 3, and an answer obtained from the information processing apparatus 1 may be transmitted from the terminal 3 to the terminal 2.

Also, the information processing apparatus 1 uses plural learning models. The information processing apparatus 1 classifies document information by using a learning model which is selected by the administrator 5 from the plural learning models, generates the plural learning models, and executes re-learning for the plural learning models. Also, the information processing apparatus 1 provides a user with information (evaluation information 114) serving as a criterion to select when the administrator 5 selects a learning model from the plural learning models.

The terminal 2 is an information processing apparatus, such as a personal computer, a mobile phone, or a tablet terminal. The terminal 2 includes electronic components, such as a CPU having a function for processing information and a flash memory having a function for storing information, and is operated by a questioner 4. Also, when a question is input by the questioner 4 to the terminal 2, the terminal 2 transmits the question as document information to the information processing apparatus 1. Alternatively, the terminal 2 may transmit a question to the terminal 3.

The terminal 3 is an information processing apparatus, such as a personal computer, a mobile phone, or a tablet terminal. The terminal 3 includes electronic components, such as a CPU having a function for processing information and a flash memory having a function for storing information, is operated by the administrator 5, and administers the information processing apparatus 1. When the terminal 3 receives a question from the terminal 2, or when a question is input to the terminal 3 by the administrator 5, the terminal 3 transmits the question as document information to the information processing apparatus 1.

The network 6 is a communication network available for high-speed communication. For example, the network 6 is a private communication network, such as an intranet or a local area network (LAN), or a public communication network, such as the internet. The network 6 may be provided in a wired or wireless manner.

Some patterns are exemplified above for transmitting a question to the information processing apparatus 1. In the following description, for the convenience of description, a case is representatively described, in which a question transmitted from the terminal 2 is received by the information processing apparatus 1, and an answer to the question is transmitted from the information processing apparatus 1 to the terminal 2.

### Configuration of Information Processing Apparatus

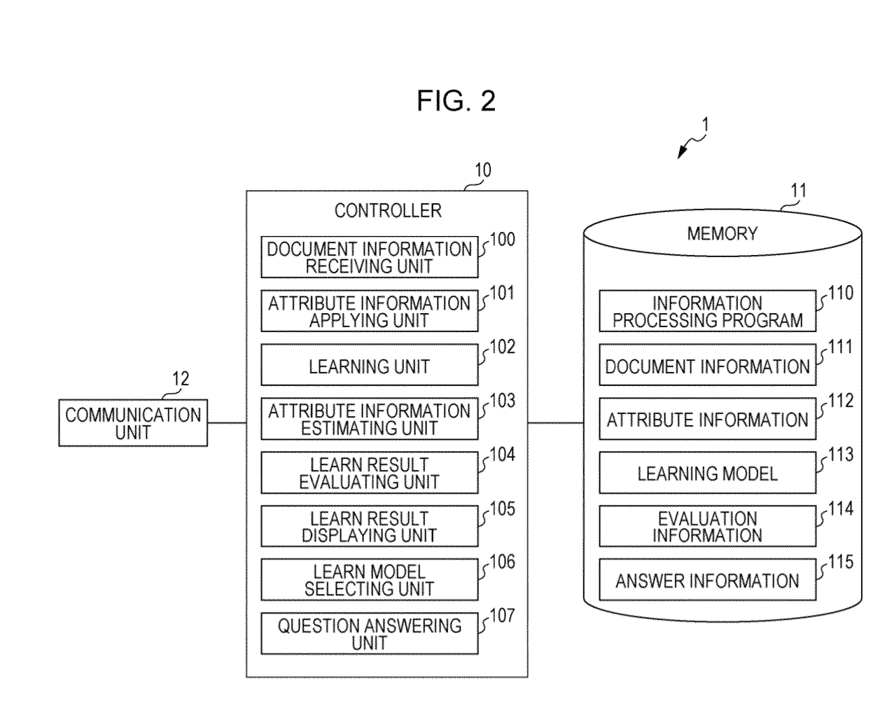

FIG. 2 is a block diagram showing an example configuration of the information processing apparatus 1 according to the exemplary embodiment.

The information processing apparatus 1 includes a controller 10 that is formed of, for example, a CPU, controls the respective units, and executes various programs; a memory 11 as an example of a memory device that is formed of, for example, a HDD or a flash memory, and stores information; and a communication unit 12 that makes communication with an external terminal through the network 6.

The information processing apparatus 1 is operated when receiving a request from the terminal 2 or 3 connected through the communication unit 12 and the network, and transmits a reply to the request to the terminal 2 or 3.

The controller 10 functions as a document information receiving unit 100, an attribute information applying unit 101, a learning unit 102, an attribute information estimating unit 103, a learn result evaluating unit 104, a learn result displaying unit 105, a learning model selecting unit 106, and a question answering unit 107, by executing an information processing program 110 (described later).

The document information receiving unit 100 receives document information 111 as a question from the terminal 2, and stores the document information 111 in the memory 11. The document information receiving unit 100 may receive document information 111 for learning from an external device (not shown).

The attribute information applying unit 101 applies attribute information 112 to the document information 111 through an operation of the terminal 3. That is, the document information 111 is classified manually by the administrator 5 through the terminal 3.

The learning unit 102 executes learning while the document information 111 with the attribute information 112 applied manually by the administrator 5 serves as an input, and generates a learning model 113. Also, the learning unit 102 executes re-learning for the learning model 113 while the document information 111 with the attribute information 112 automatically applied by the attribute information estimating unit 103 (described later) serves as an input. A learning model is used by the attribute information estimating unit 103 as described below to find similarity among plural pieces of document information 111, to which certain attribute information 112 serving as learn data is applied, and to apply attribute information to document information 111, to which attribute information 112 not serving as learn data is not applied.

The attribute information estimating unit 203 estimates and applies the attribute information 112 to the document information 111 input in accordance with the learning model 113.

The learn result evaluating unit 104 evaluates the learn result of the learning model 113 generated by the learning unit 102 or the learn result of the learning model 113 after re-learning, and generates evaluation information 114. The evaluation method is described later.

The learn result displaying unit 105 outputs the evaluation information 114 generated by the learn result evaluating unit 104 to the terminal 3, as information that may be displayed on the display of the terminal 3.

The learning model selecting unit 106 selects the learning model to be used by the attribute information estimating unit 103 from among the plural learning models 113 through an operation of the terminal 3 by the administrator 5.

Alternatively, the learning model selecting unit 106 may automatically select a learning model under a predetermined condition by using the evaluation information 114 generated by the learn result evaluating unit 104. The predetermined condition may be a condition that extracts a learning model having a cross-validation accuracy (described later) as the evaluation information 114 being a certain value or larger, or that selects a learning model having the highest cross-validation accuracy. The cross-validation accuracy does not have to be necessarily employed, and other parameter may be used. Also, plural parameters contained in the evaluation information 114 (for example, cross-validation accuracy and work type) may be used. In this case, the learn result displaying unit 105 that displays the content of the evaluation information 114 may be omitted.

The question answering unit 107 selects answer information 115 as an answer to the document information 111 as a question, in accordance with the attribute information 112 applied to the document information 111 estimated by the attribute information estimating unit 103, and outputs the answer information 115 to the terminal 2.

The memory 11 stores the information processing program 110, the document information 111, the attribute information 112, the learning model 113, the evaluation information 114, the answer information 115, etc.

The information processing program 110 causes the controller 10 to operate as the units 100 to 107.

The information processing apparatus 1 is, for example, a server or a personal computer. Otherwise, a mobile phone, a tablet terminal, or other device may be used.

Also, the information processing apparatus 1 may further include an operation unit and a display, so as to operate independently without an external terminal.

### Operation of Information Processing Apparatus

Next, operations of this exemplary embodiment are described by dividing the operations into (1) learning model generating operation, (2) re-learning operation, and (3) answering operation.

First, overviews of operations are described. In “(1) learning model generating operation,” learning is executed by using document information, to which attribute information is applied by the administrator 5, and generates a learning model. The learning model is generated plural times to obtain plural learning models by repeating “(1) learning model generating operation.”

A learning model may be generated in view of, for example, a type (question, answer, etc.), a category (tax, pension problem, etc.), a work type (manufacturing industry, service business, etc.), a time element (quarterly (seasonal), monthly, etc.), a geographical element, legal changes, etc. These points of view are merely examples, and a learning model may be generated in various points of view.

Also, a learning model is newly generated by executing re-learning in “(2) re-learning operation” (described later). That is, learning models are generated so that a learning model before re-learning and a learning model after re-learning are individually present. Alternatively, a new learning model may not be generated by re-learning additionally to a learning model before re-learning, and one learning model may be updated by re-learning.

Next, in “(2) re-learning operation,” attribute information is applied to new document information without attribute information in accordance with a learning model generated in “(1) learning model generating operation.” Also, re-learning is executed for the learning model by using the document information with the attribute information applied. The evaluation information including the result of re-learning is provided to the administrator 5 for all learning models. The administrator 5 selects a proper learning model for a learning model used in “(3) answering operation.” Alternatively, “(2) re-learning operation” may be periodically executed.

The re-learning operation is executed at a timing corresponding to a state in which the attribute information is associated. For example, if attribute information is applied to document information received from a questioner by using a known learning model, re-learning may be executed at a timing when the number of pieces of specific attribute information associated with the document information is changed. For a specific example, if a law relating to a tax is changed, the number of pieces of attribute information (“tax” etc.) associated with the document information may be changed (increased, decreased, etc.). In this case, it is desirable to execute re-learning for the learning model. Also, for another example, re-learning may be executed at a periodical timing (including timing on the time basis), such as quarterly (seasonal) or monthly.

Also, document information, to which attribute information used in “(2) re-learning operation” is applied, may not be necessarily document information, to which attribute information is applied by using a learning model generated in “(1) learning model generating operation.” That is, only required is to prepare document information with attribute information applied, provide the result of re-learning for a learning model by using the document information and evaluation information to the administrator 5, and select a learning model to be used in “(3) answering operation” in accordance with the evaluation information.

Then, in “(3) answering operation,” attribute information is estimated for document information serving as a question transmitted from the questioner 4, by using the learning model finally selected in “(2) re-learning operation,” and answer information serving as an answer suitable for the estimated attribute information is transmitted to the questioner 4. The details of the respective operations are described below.

### (1) Learning Model Generating Operation

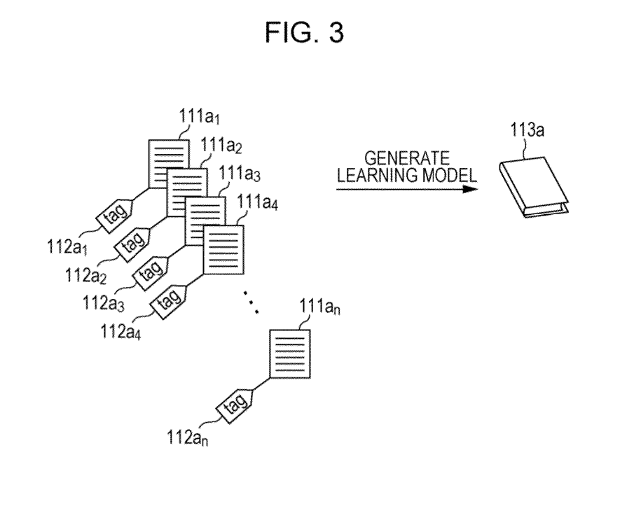

FIG. 3 is a schematic view for illustrating an example of a learning model generating operation.

As shown in FIG. 3, first, the administrator 5 operates the operation unit of the terminal 3 to apply attribute information 112a₁ to 112aₙ to document information 111a₁ to 111aₙ, respectively. Alternatively, plural pieces of attribute information may be applied to a single document. Also, attribute information applied to certain document information may be the same as attribute information applied to another document. In this exemplary embodiment, as shown in FIG. 3 and later drawings, attribute information is expressed by “tag.” A type, a category, a work type, etc. are prepared for the attribute information 112a₁ to 112aₙ.

The terminal 3 transmits a request for applying an attribute name, to the information processing apparatus 1.

In response to the request from the terminal 3, the attribute information applying unit 101 of the information processing apparatus 1 displays an attribute information input screen 101a on the display of the terminal 3, and receives an input of attribute information such as a type, a category, etc.

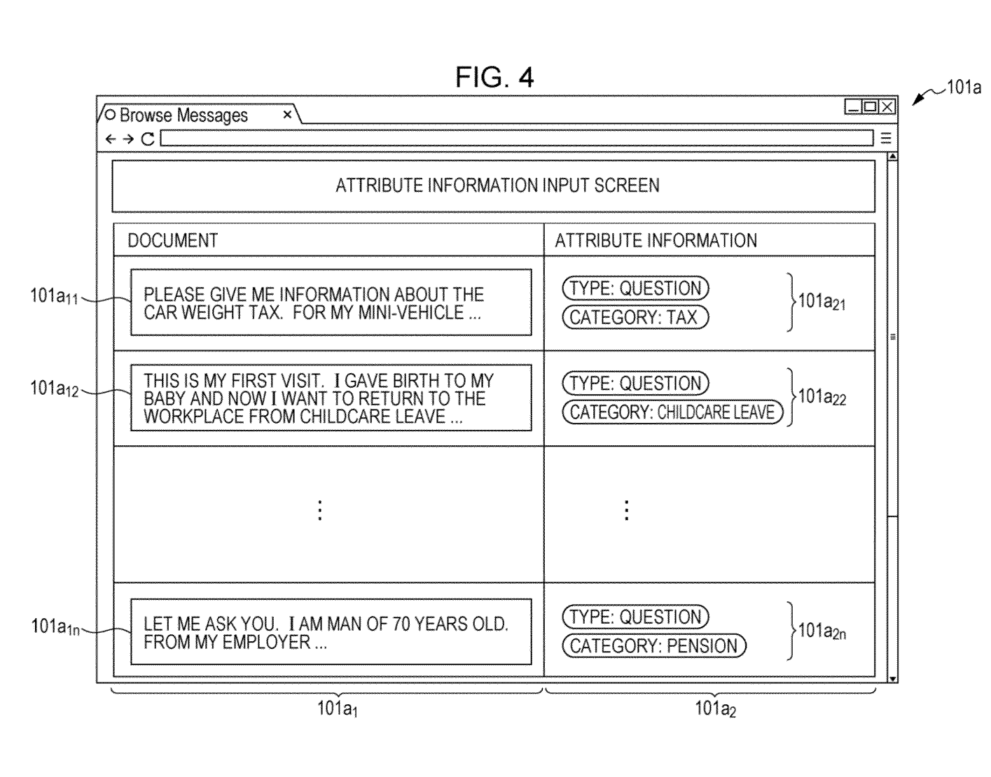

FIG. 4 is a schematic view for illustrating an example configuration of the attribute information input screen 101a that receives an input of attribute information.

The attribute information input screen 101a includes a question content reference area 101a₁ indicative of contents of the document information 111a₁ to 111aₙ, and an attribute content reference and input area 101a₂ indicative of contents of the attribute information 112a₁ to 112aₙ.

The administrator 5 checks the contents of the document information 111a₁ to 111aₙ for question contents 101a₁₁, 101a₁₂, . . . , and a type, such as “question” and a category, such as “tax” are input to each of attribute contents 101a₂₁, 101a₂₂, . . . .

The contents of the attribute information 112a₁ to 112aₙ are not limited to the type and the category, and different points of view, such as a work type, a region, etc., may be input. For example, the content of work type may be service business, manufacturing industry, agriculture, etc., and the content of region may be Tokyo, Kanagawa, etc.

Also, plural pieces of information may be input to the content of each piece of the attribute information 112a₁ to 112aₙ. “Tax” may be input to the category, “Manufacturing Industry” may be input to the work type, and “Kanagawa” may be input to the region.

Then, when the type, category, etc., are input to the attribute content reference and input area 101a₂, the attribute information applying unit 101 applies the input information to each of the plural pieces of document information 111a₁ to 111aₙ, and stores the information in the memory 11 as the attribute information 112a₁ to 112aₙ.

Then, the administrator 5 operates the operation unit of the terminal 3 to generate a learning model 113a by using the document information 111a₁ to 111aₙ with the attribute information 112a₁ to 112aₙ applied.

The terminal 3 transmits a request for generating a learning model, to the information processing apparatus 1.

In response to the request from the terminal 3, the learning unit 102 of the information processing apparatus 1 displays a classification screen 102a on the display of the terminal 3, and receives start of learning.

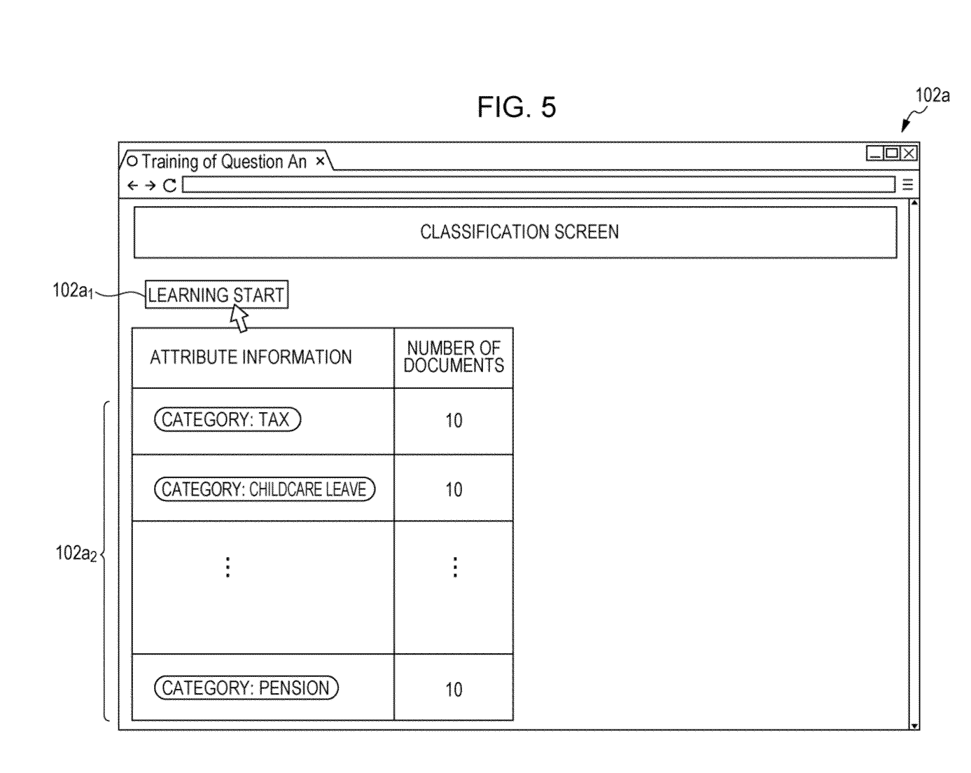

FIG. 5 is a schematic view for illustrating an example configuration or the classification screen 102a that receives start of learning.

The classification screen 102a includes a learning start button 102a₁ that requests start of learning, and a category 102a₂, as an example of attribute information included in the document information 111a₁ to 111aₙ with the attribute information 112a₁ to 112aₙ applied, as a subject of learning.

The administrator 5 operates the learning start button 102a₁ and requests generation of a learning model. The terminal 3 transmits the request to the information processing apparatus 1.

In response to the request for generating the learning model, as shown in FIG. 3, the learning unit 102 of the information processing apparatus 1 generates the learning model 113a by using the document information 111a₁ to 111aₙ with the attribute information 112a₁ to 112aₙ applied, respectively.

Also, for the generated learning model 113a, for example, the learn result evaluating unit 104 generates the evaluation information 114 for evaluating the learn result by performing cross validation and hence calculating a cross-validation accuracy. The learn result displaying unit 105 displays the evaluation information 114 of the learn result on the display of the terminal 3.

The cross validation represents that, if there are plural pieces of document information 111 with attribute information 112 applied, the plural pieces of document information 111 are divided into sets of n pieces of data, an evaluation index value is calculated while 1 piece of divided data serves as evaluation data and residual n−1 pieces of data serve as training data, the calculation is repeated n times for all data, and a mean value of thus obtained n evaluation index values is obtained as a cross-validation accuracy.

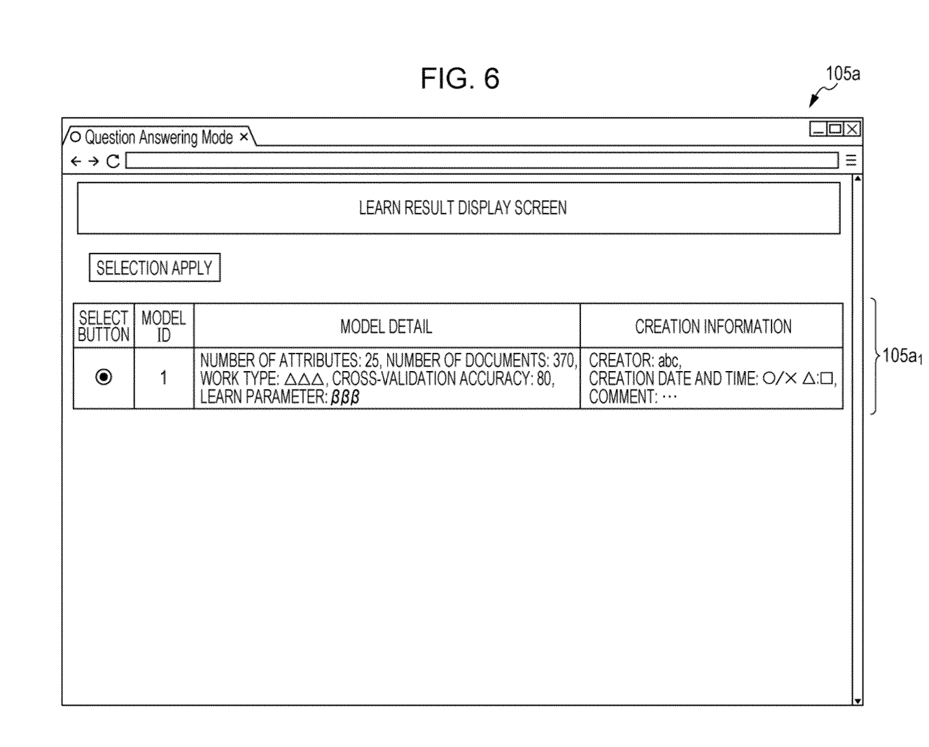

Alternatively, the evaluation information 114 may include other evaluation value for a work type etc., and may further include other parameters such as a type, in addition to the cross-validation accuracy, as shown in “model detail” in FIG. 6.

FIG. 6 is a schematic view for illustrating an example configuration of a learn result display screen 105a indicative of a content of evaluation information of a learn result.

The learn result display screen 105a displays a learn result 105a₁ including select button for selecting a learning model, model ID for identifying the learning model, model detail indicative of the detail of the learning model, and creation information indicative of a creator who created the learning model, etc.

The model detail displays number of attributes indicative of the number of attributes associated with document information used for generation of the learning model, number of documents indicative of the number of documents used for generation of the learning model, work type indicative of the content of work type as an example point of view in which the learning model is generated, the above-described cross-validation accuracy, learn parameter used for generation of the learning model, etc. Also, the model detail may further include other parameter such as a type.

Also, the creation information displays creator indicative of a creator who creates the learning model, creation date and time indicative of date and time when the learning model is created, and comment indicative of a comment for the point of view etc. when the learning model is created.

The administrator 5 repeats the above-described operation, and generates plural learning models.

### (2) Re-Learning Operation

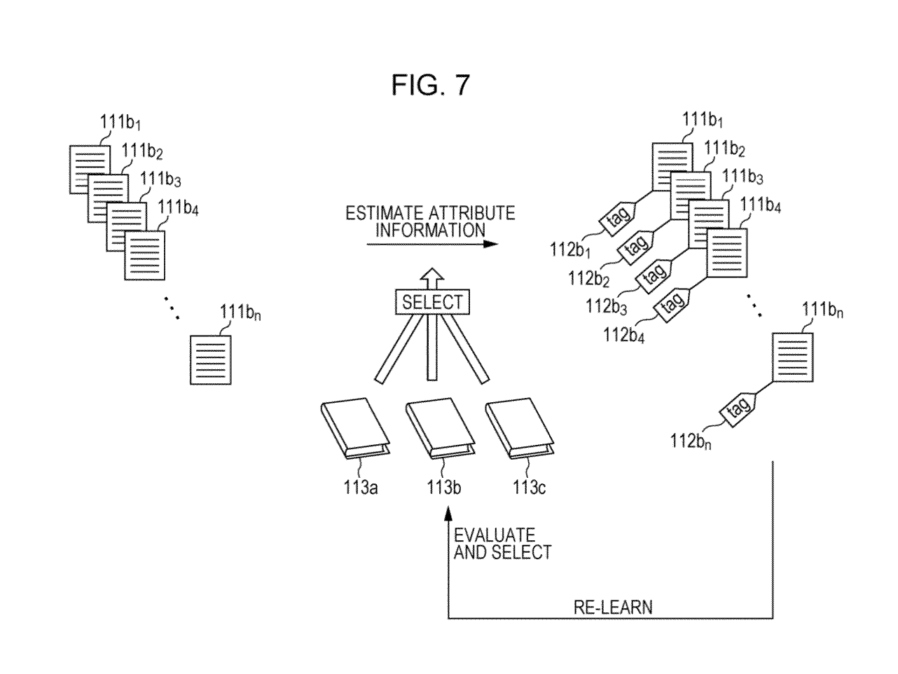

FIG. 7 is a schematic view for illustrating an example of a re-learning operation.

As shown in FIG. 7, first, the administrator 5 operates the operation unit of the terminal 3 to execute re-learning for plural learning models 113a to 113c generated by “(1) learning model generating operation”. Alternatively, the learning models 113a to 113c may use learning models generated by other system.

The terminal 3 transmits a request for re-learning to the information processing apparatus 1.

In response to the request from the terminal 3, the document information receiving unit 100 of the information processing apparatus 1 receives document information 111b₁ to 111bₙ serving as learning data used for re-learning.

Then, the learning model selecting unit 106 displays a learning model selection screen 106a on the display of the terminal 3, and hence receives selection of any learning model (a first learning model) from among the learning models 113a to 113c for estimating attribute information to be applied to the document information 111b₁ to 111bₙ.

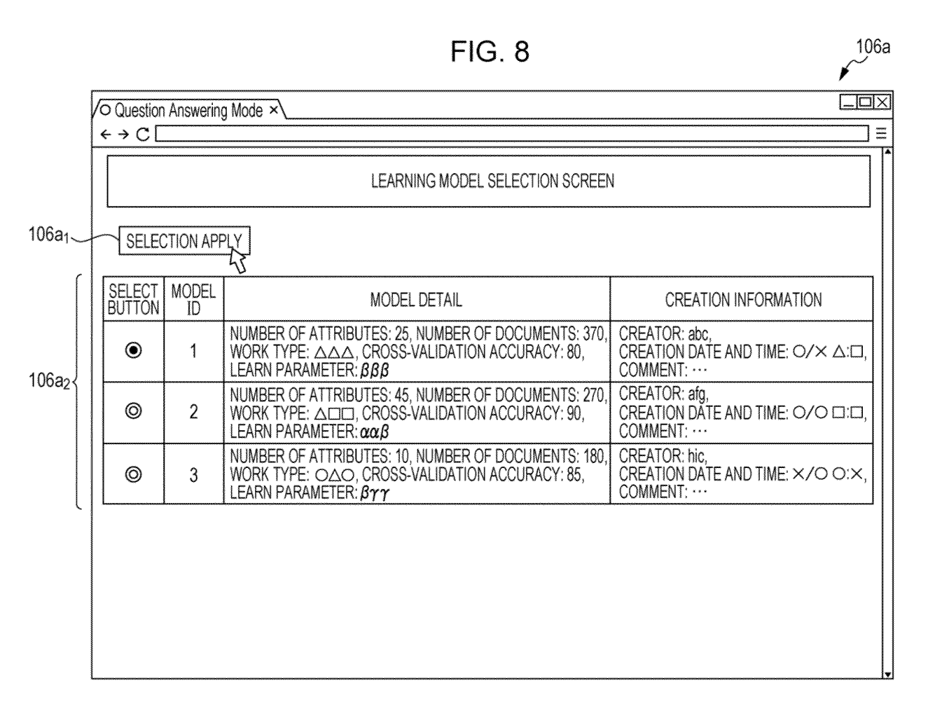

FIG. 8 is a schematic view for illustrating an example configuration of the learning model selection screen 106a.

The learning model selection screen 106a includes a selection apply button 106a₁ for determining a selection candidate, and learning model candidates 106a₂ indicative of candidates of learning models. In the learning model candidates 106a₂, plural evaluation values including the “cross-validation accuracy” as an example of a value indicative of accuracy are written in the field of the model detail in accordance with the evaluation information 114. The administrator 5 references the “cross-validation accuracy” for a representative example from among the evaluation values, and determines the candidate to be selected.

The administrator 5 selects one by clicking one of select buttons prepared for the learning model candidates 106a₂ in the learning model selection screen 106a, and determines the selection by clicking the selection apply button 106a₁. In the example shown in FIG. 8, one is selected from three candidates (model IDs “1” to “3”) corresponding to the learning models 113a to 113c shown in FIG. 7.

Then, the attribute information estimating unit 103 displays an attribute information estimation screen 103b on the display of the terminal 3.

FIG. 3 is a schematic view for illustrating an example configuration of the attribute information estimation screen 103b.

The attribute information estimation screen 103b includes an at tribute-estimation start button 103b₁ for a request to start estimation of attribute information, a question content reference area 103b₂ indicative of contents of document information 103b₂₁ to 103b₂ₙ corresponding to the document information 111b₁ to 111bₙ in FIG. 7, and an attribute content reference area 103b₃ indicative of contents of attribute information 103b₃₁ to 103b₃ₙ applied to the document information 103b₂₁ to 103b₂ₙ.

In the attribute information estimation screen 103b, by clicking the attribute-estimation start button 103b₁, the administrator 5 requests estimation of attribute information to be applied to the document information 111b₁ to 111bₙ by using a first learning model selected from the learning models 113a to 113c shown in FIG. 7 on the learning model selection screen 106a.

The attribute information estimating unit 103 applies attribute information 112b₁ to 112bₙ to the document information 111b₁ to 111bₙ by using the first learning model selected from the learning models 113a to 113c shown in FIG. 7.

Then, the learning unit 102 executes learning for each of the learning models 113a to 113c while the document information 111b₁ to 111bₙ with the attribute information 112b₁ to 112bₙ shown in FIG. 7 applied serve as inputs.

Also, for the generated learning models 113a to 113c, the learn result evaluating unit 104 generates the evaluation information 114 by performing cross validation and evaluating the learn result. The learn result displaying unit 105 displays the evaluation information 114 of the learn result on the display of the terminal 3.

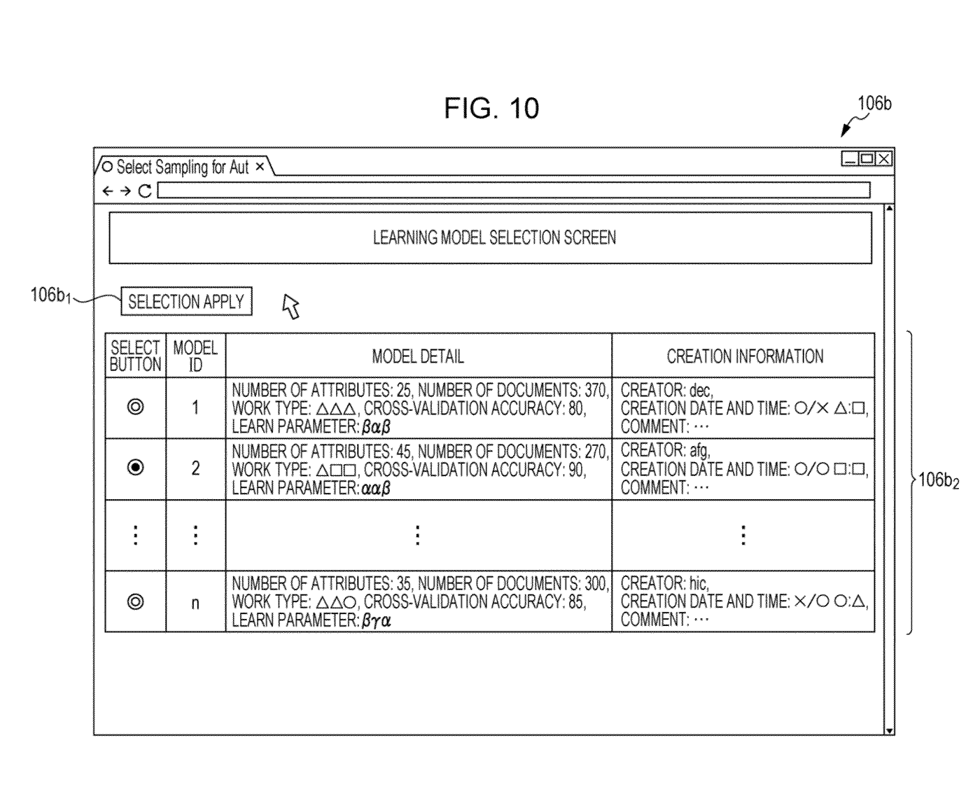

FIG. 10 is a schematic view for illustrating an example configuration or a learning model selection screen 106b.

The learning model selection screen 106b includes a selection apply button 106b₁ for determining a selection candidate, and learning model candidates 106b₂ indicative of candidates of learning models. In the learning model candidates 106b₂, plural evaluation values including the “cross-validation accuracy” as an example of a value indicative of accuracy are written in the field of the model detail in accordance with the evaluation information 114. The administrator 5 references the “cross-validation accuracy” for a representative example from among the evaluation values, and uses the “cross-validation accuracy” as a first reference to determine the candidate to be selected. Alternatively, plural evaluation values may serve as a first reference.

In the learning model candidates 106b₂, for example, the learn result displaying unit 105 displays learning models in the order from a learning model with a higher “cross-validation accuracy” indicative of the accuracy, and provides the learning models to the administrator 5. However, since the “cross-validation accuracy” is only a statistical value indicative of evaluation of a learning model, other statistical values not shown in the model detail are provided to the administrator 5 by the following method.

The administrator 5 may select the learning model candidate 106b₂ and request displaying of the detail of the evaluation information 114 (described later). The administrator 5 regards the detail of the evaluation information 114 as a second reference.

The administrator 5 selects one by clicking one of select buttons prepared for the learning model candidates 106b₂ in the learning model selection screen 106b, and determines the selection of the learning model, the detail of the evaluation information 114 of which is displayed, by clicking the selection apply button 106b₁. In the example in FIG. 10, the number of candidates is n; however, in this case, selection is made from three candidates corresponding to the learning models 113a to 113c shown in FIG. 7.

The learn result displaying unit 105 displays the detail of the evaluation information 114 of the learn result on the display of the terminal 3.

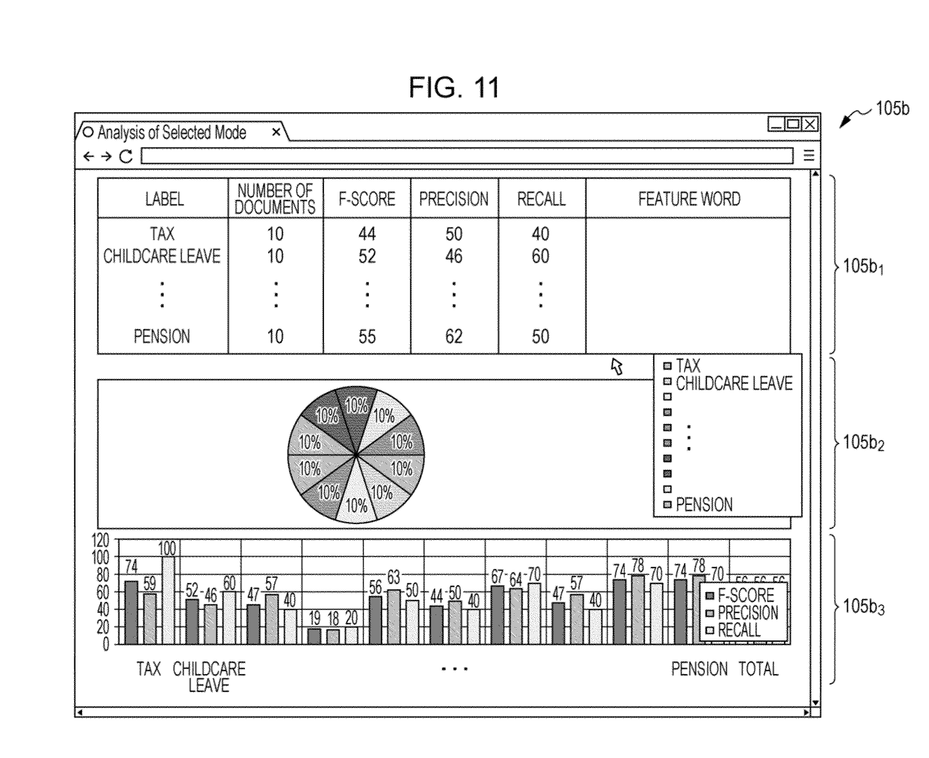

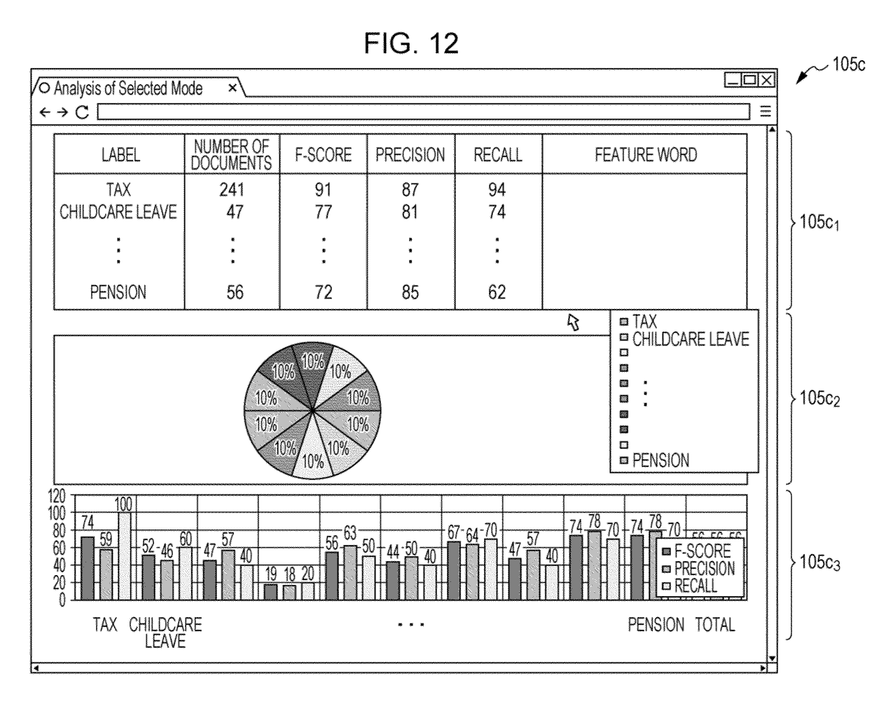

The learn result evaluating unit 104 provides evaluation values respectively for plural types of attribute information as described below, as the detail of the evaluation information 114. The detail of the evaluation information 114 may be displayed even before re-learning. The detail of evaluation information 114 before re-learning (FIG. 11) and the detail of evaluation information 114 after re-learning (FIG. 12) are exemplified.

The detail of the evaluation information 114 is generated such that the attribute information estimating unit 103 estimates attribute information 112 to be applied, for test document information with attribute information previously applied, and the learn result evaluating unit 104 compares the attribute information estimated by the attribute information estimating unit 103 with the previously applied attribute information and evaluates the attribute information.

FIG. 11 is a schematic view for illustrating an example configuration of a learning model analysis screen 105b before re-learning.

The learning model analysis screen 105b is a screen indicative of the detail of the evaluation information 114 before re-learning, and includes detail information 105b₁ indicative of statistical values such as “F-score,” “precision,” and “recall,” for attribute information “label”; a circle graph 105b₂ indicative of the ratio of the number of each piece of attribute information to the entire number; and a bar graph 105b₃ indicative of statistical values of each piece of attribute information.

If document information 111 with attribute information 112 as a correct answer applied is prepared for evaluation information, the “precision” represents a ratio of actually correct answers from among information expected to be correct. To be more specific, the “precision” represents a ratio of the number of pieces of document information 111 with attribute information 112 actually correctly applied by the attribute information estimating unit 103, to the number of pieces of document information 111 to which attribute information 112 is recognized to be correctly applied by the attribute information estimating unit 103.

The “recall” is a ratio of information expected to be correct from among actually correct information. To be more specific, the “recall” is a ratio of the number of pieces of document information 111 to which the attribute information estimating unit 103 correctly applies attribute information, to the number or pieces of document information 111 with correct attribute information applied.

Also, the “F-score” is a value obtained from a harmonic mean between the precision and the recall.

FIG. 12 is a schematic view for illustrating an example configuration of a learning model analysis screen 105c after re-learning.

The learning model analysis screen 105c is a screen indicative of the detail of the evaluation information 114 after re-learning.

Screen configurations of FIG. 11 and FIG. 12 are the same. That is, the learning model analysis screen 105c includes detail information 105c₁ indicative of statistical values such as “F-score,” “precision,” and “recall,” for attribute information “label”; a circle graph 105c₂ indicative of the ratio of the number of each piece of attribute information to the entire number; and a bar graph 105c₃ indicative of statistical values of each piece of attribute information.

Now, as compared with the learning model analysis screen 105b shown in FIG. 11, the precision of the “tax” is increased from “50” to “87” and thus re-learning of the learning model is successful. While all statistical values are increased in FIG. 12 as compared with FIG. 11, re-learning of the learning model may be successful as long as any of the statistical values is increased.

The learn result displaying unit 105 may not only provide the statistical values as the evaluation information 114 to the administrator 5, but also monitor correlation between parameters, such as the attribute name, season, region, work type, etc., of attribute information and statistical values, and may provide a learning model the correlation of which exceeds a predetermined threshold to the administrator 5.

### (3) Answering Operation

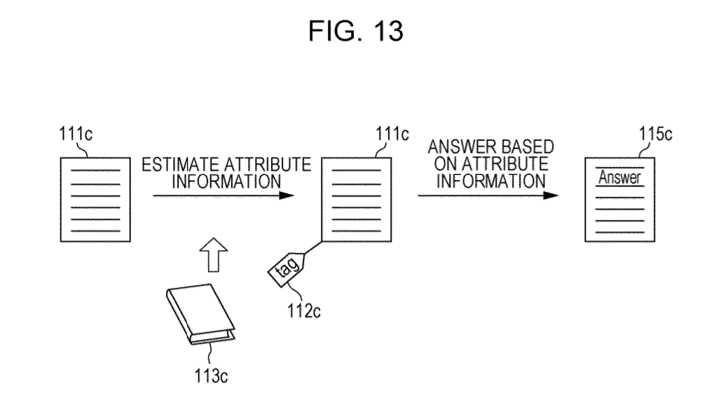

FIG. 13 is a schematic view for illustrating an example of an answering operation.

Described below is a case in which the administrator 5 checks the detail of the evaluation information 114 in “(2) re-learning operation” and selects, for example, the learning model 113c as a learning model (a second learning model) used for the answering operation.

First, the questioner 4 requests an input of a question to the information processing apparatus 1 through the terminal 2.

The document information receiving unit 100 of the information processing apparatus 1 displays a question input screen 100a on the display of the terminal 2 in response to the request.

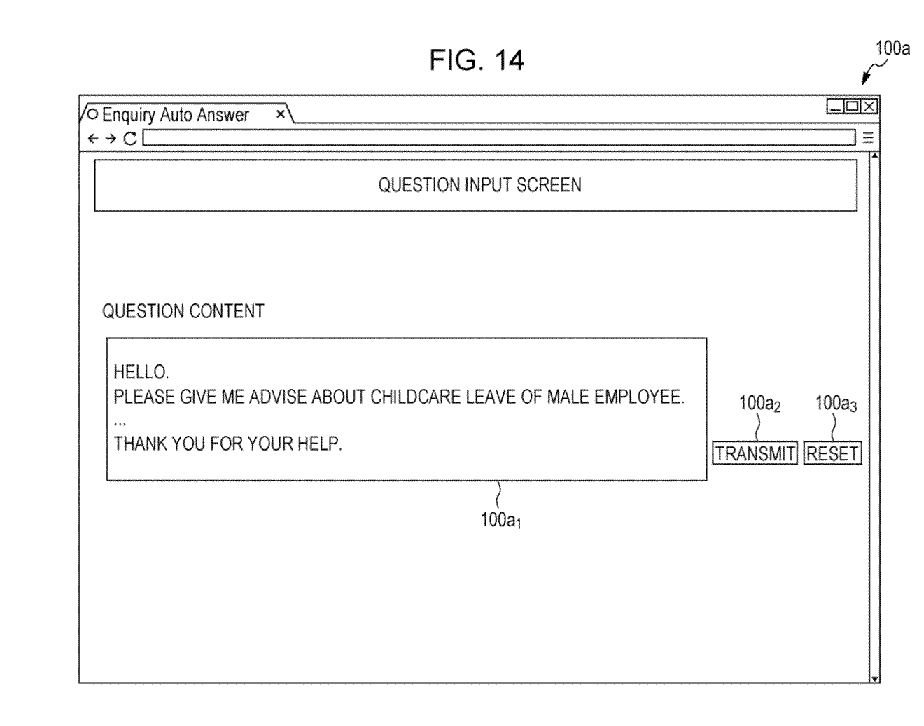

FIG. 14 is a schematic view for illustrating an example configuration or the question input screen 100a.

The question input screen 100a includes a question input field 100a₁ in which the questioner 4 inputs a question, a question request button 100a₂ for requesting transmission of the question with the content input in the question input field 100a₁ as document information no the information processing apparatus 1, and a reset button 100a₃ for resetting the content input in the question input field 100a₁.

The questioner 4 inputs the question in the question input field 100a₁, and clicks the question request button 100a₂.

The terminal 2 transmits the content input in the question input field 100a₁ as the document information to the information processing apparatus 1 through the operation of the questioner 4.

The document information receiving unit 100 of the information processing apparatus 1 receives document information 111c as the question of the questioner 4 from the terminal 2.

Then, the attribute information estimating unit 103 estimates attribute information 112c for the document information 111c by using the second learning model 113c selected by the administrator 5.

Then, the question answering unit 107 selects answer information 115c corresponding to the attribute information estimated by the attribute information estimating unit 103 from answer information 115, and transmits the selected answer information 115c to the terminal 2.

The terminal 2 displays an answer display screen 107a in accordance with the answer information 115c received from the information processing apparatus 1.

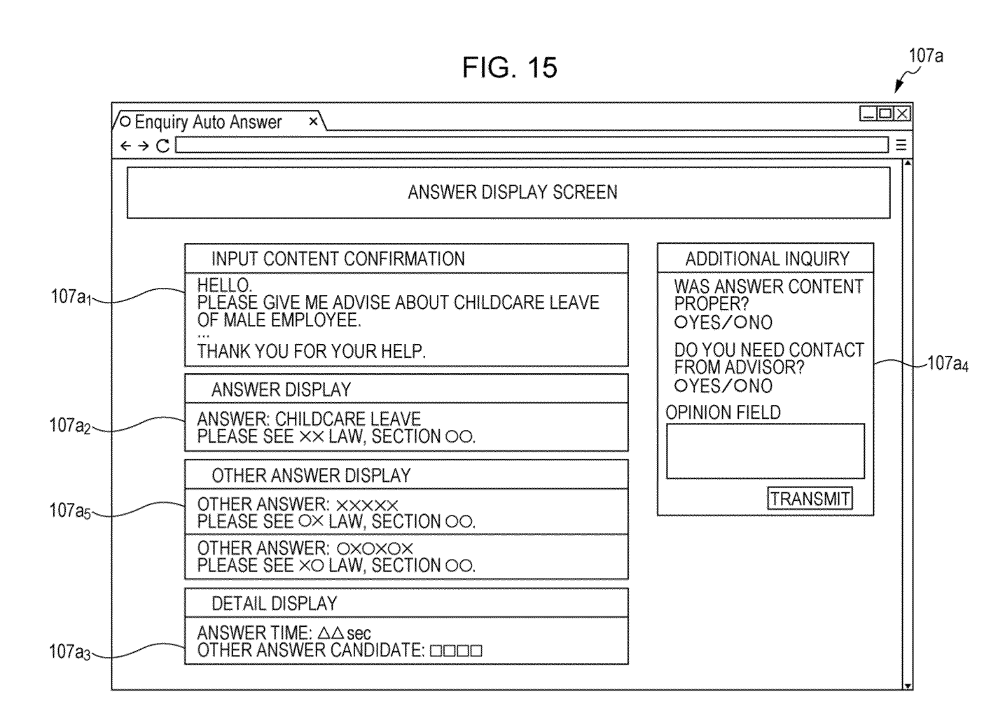

FIG. 15 is a schematic view for illustrating an example configuration of the answer display screen 107a.

The answer display screen 107a includes an input content confirmation field 107a indicative of the content of the question input in the question input field 100a₁, an answer display field 107a₂ indicative of the content of an answer to the question, a detailed display field 107a₃ indicative of detailed information such as a time required since the information processing apparatus 1 receives the question until the information processing apparatus 1 transmits the answer, an additional inquiry display field 107a₄ for making an inquiry etc. if the questioner 4 is not satisfied with the content of the answer, and an other answer display field 107a₅ indicative of other answer candidates other than the answer displayed in the answer display field 107a₂.

The questioner 4 checks the contents of the answer display screen 107a, and makes another question by using the additional inquiry display field 107a₄ if required.

### Other Exemplary Embodiment

The invention is not limited to the above-described exemplary embodiment, and may be modified in various ways without departing from the scope of the invention. For example, the following configuration may be employed.

In the above-described exemplary embodiment, the functions of the units 100 to 107 in the controller 10 are provided in the form of programs; however, all the units or part of the units may be provided in the form of hardware such as an application-specific integrated circuit (ASIC). Also, the programs used in the above-described exemplary embodiment may be stored in a storage medium such as a compact-disk read-only memory (CD-ROM). Also, the order of the steps described in the exemplary embodiment may be changed, any of the steps may be deleted, and a step may be added without changing the scope of the invention.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A non-transitory computer readable medium storing a program causing a computer to execute a process for information processing, the process comprising:
evaluating a plurality of learning models;
displaying an evaluation result of the evaluation;
selecting a first learning model from the displayed plurality of learning models;
estimating attribute information to be applied to document information, in accordance with the first learning model; and
executing learning by using at least one of the plurality of learning models while the document information with the estimated attribute information applied serves as an input.

2. The medium according to claim 1,
wherein the evaluation evaluates the plurality of learning models after the learning,
wherein the displaying displays the plurality of learning models after the learning, together with the evaluation result, and
wherein the selection selects a second learning model to be used for the estimation from the displayed plurality of learning models.

3. The medium according to claim 2,
wherein the estimation estimates attribute information to be applied to document information serving as a question to be input, in accordance with the selected second learning model, and
wherein the process further comprises answering to a question source of the question by selecting answer information serving as an answer in accordance with the estimated attribute information.

4. The medium according to claim 1, wherein the displaying changes the displaying order of the plurality of learning models in accordance with the evaluation result of the evaluation.

5. The medium according to claim 1,
wherein the evaluation evaluates correlation between the evaluation result and other parameter, and
wherein the displaying changes the displaying order of the plurality of learning models in accordance with the evaluated correlation.

6. An information processing apparatus, comprising:
an evaluating unit that evaluates a plurality of learning models;
a displaying unit that displays an evaluation result of the evaluating unit;
a selecting unit that selects a first learning model from the plurality of learning models displayed by the displaying unit;
an estimating unit that estimates attribute information to be applied to document information, in accordance with the first learning model; and
a learning unit that executes learning by using at least one of the plurality of learning models while the document information with the attribute information estimated by the estimating unit applied serves as an input.

7. A non-transitory computer readable medium storing a program causing a computer to execute a process for information processing, the process comprising:
evaluating a plurality of learning models;
selecting a learning model corresponding to an evaluation result that satisfies a predetermined condition from the plurality of learning models, as a first learning model;
estimating attribute information to be applied to document information, in accordance with the first learning model; and
executing learning by using at least one of the plurality of learning models while the document information with the attribute information applied by the estimation serves as an input.

8. An information processing apparatus, comprising:
an evaluating unit that evaluates a plurality of learning models;
a selecting unit that selects a learning model corresponding to an evaluation result that satisfies a predetermined condition from the plurality of learning models, as a first learning model;
an estimating unit that estimates attribute information to be applied to document information, in accordance with the first learning model; and
a learning unit that executes learning by using at least one of the plurality of learning models while the document information with the attribute information applied by the estimating unit serves as an input.

9. An information processing method, comprising:
evaluating a plurality of learning models;
displaying an evaluation result of the evaluation;
selecting a first learning model from the displayed plurality of learning models;
estimating attribute information to be applied to document information, in accordance with the first learning model; and
executing learning by using at least one of the plurality of learning models while the document information with the estimated attribute information applied serves as an input.
